(19) United States
(12) Patent Application Publication
(10) Pub. No.: US 2024/0084512 A1
(43) Pub. Date: Mar. 14, 2024

(54) Waterproof Paper Utensils and Method for Making Waterproof Paper Utensils

(71) Applicant: J & J GREEN PAPER, INC., COCONUT GROVE, FL (US)

(72) Inventor: Michael Scott Segal, Coconut Grove, FL (US)

(73) Assignee: J & J GREEN PAPER, INC., COCONUT GROVE, FL (US)

(21) Appl. No.: 18/452,503

(22) Filed: Aug. 18, 2023

Related U.S. Application Data
(60) Provisional application No. 63/371,821, filed on Aug. 18, 2022.

(51) Int. Cl. D21H 21/16; A47G 21/02; A47G 21/04; B31D 5/00

(52) U.S. Cl. CPC D21H 21/16; A47G 21/023; A47G 21/04; B31D 5/00

(57) ABSTRACT

Waterproofed paper and paperboard forms utensils, tools, and cutlery. The waterproofed paper is made by applying a waterproof composition to the paper and then cutting and molding the waterproofed paper to the shape of a utensil, tool, or piece of cutlery. Paper and paperboard that is particularly useful in forming strong utensils, tools, and cutlery that do not bend or snap during normal use.

### CROSS-REFERENCE TO RELATED APPLICATIONS

This application claims the benefit of U.S. Provisional Application No. 63/371,821, filed Aug. 18, 2022, which is hereby incorporated by reference.

This application is related to prior application Ser. No. 16/191,426, filed Nov. 14, 2018, which issued as U.S. Pat. No. 11,401,661, which claims the benefit of U.S. provisional applications, Ser. No. 62/585,962, filed Nov. 14, 2017, Ser. No. 62/599,234, filed Dec. 15, 2017, and 62/659,186, filed Apr. 20, 2018, all of which are hereby incorporated by reference.

### BACKGROUND OF THE INVENTION

### Field of the Invention

The invention relates to biodegradable utensils, flatware, and packaging, and particularly to biodegradable waterproofed vulcanized paper-based utensils, flatware, and packaging.

### Description of Related Art

Disposable cups, which are made of materials that are cheap enough to be used only once, allow people to drink beverages at locations where there is no dishwasher or to take beverages on the go and never return the cup. After the drinker finishes the beverage, regardless of location, the drinker disposes of the cup in the garbage. A hidden cost of disposable cups is the disposal costs, which include the cost of moving the disposable cup to a landfill and the environmental cost of allowing the disposable cup to degrade.

To mitigate the hidden cost of disposable cups, a solution might call for recycling the disposable cups. Recycling decreases the hidden costs by decreasing the amount of materials entering landfills. In addition, recycling reduces the hidden cost of depleting raw materials. Unfortunately, for the reasons detailed below, the most preferred forms of hot beverage containers cannot be recycled in a cost-effective manner.

Cellulose material (e.g., paper and cardboard) is one of the materials commonly used to make disposable, hot beverage containers. Disposable cups for holding hot beverages cannot be made from paper alone. Without additives, cellulose material alone is not a satisfactory material for making hot beverage containers because the cellulose material will soften from absorbing hot water. A cellulose container that has absorbed liquid will become so soft that the container cannot be held without collapsing. Eventually, the cellulose container will absorb enough water that the paper will form a slurry with the water, the paper will tear, and liquids will escape the cellulose container.

To solve the problem of paper alone, additives are used to enhance the waterproofing of the cellulose material. Commonly, paper and card stock are treated with polyethylene (PE), then formed into a cup. In PE-coated cups, the paper or paperboard is coated with a very thin layer of PE. The PE waterproofs the paper and welds and seals the seams of the cup. Coating paper cups with PE has the side effect of making the PE-coated cup unrecyclable.

Sugarcane wax naturally occurs within sugarcane. Sugarcane wax is a byproduct of sugar production from sugarcane. Sugarcane wax can be characterized as a wax in which about seventy percent (˜70%) of the weight of the wax is composed of alcohols of long-chain hydrocarbons having chain lengths of C 18 to C 32, wax acids having chain lengths of C 18 to C 32, ω-hydroxycarboxylic acids, and aromatic carboxylic acids. Sugarcane wax additionally can include fatty alcohols (wax alcohols) and diols. Besides that, about 5 to 10% of sugarcane wax is composed of unesterified diols, long-chain wax acids such as behenic, cerotic, lignoceric or melissic acid and saturated hydrocarbons.

Emulsions of sugarcane wax can be used to wash fruits and vegetables to give them a gloss and to lengthen shelf life. Sugarcane wax is indigestible and harmless to health. In its refined form it has a light yellowish color. Sugarcane has a melting point between 75 and 80° C.

Rice bran wax is the vegetable wax extracted from the bran oil of rice (Oryza sativa). The main components of rice bran wax are aliphatic acids (wax acids) and higher alcohol esters. The aliphatic acids consist of palmitic acid (C16), behenic acid (C22), lignoceric acid (C24), other higher wax acids. The higher alcohol esters consist mainly of ceryl alcohol (C26) and melissyl alcohol (C30). Rice bran wax also contains constituents such as free fatty acids (palmitic acid), squalene and phospholipids. Rice bran wax has a melting point between 77-86° C.

Vulcanized Paper

Vulcanized fiber or red fiber is a laminated “plastic” (i.e., a material capable of being shaped or formed) composed of only cellulose. The material is a tough, resilient, hornlike material that is lighter than aluminum, tougher than leather, and stiffer than most thermoplastics. Newer wood-laminating grades of vulcanized fiber are used to strengthen wood laminations used in skis, skateboards, support beams and as a sub-laminate under thin wood veneers.

Vulcanized fiber has a long history in engineering, from the Victorian period onward. Although there are now many materials, mostly synthetic polymers, with higher performance, fiber has been applied widely and still retains many applications. As it is stronger in thin sections between mechanically rigid components, rather than relying on its own strength, it has mostly been used as washers, gaskets, and a variety of shims or packing pieces.

Fiber washers are one of the cheapest conformal elastomer gaskets for sealing pipe unions and general plumbing work. They swell slightly with exposure to water, making a good seal. They may also be used with hydrocarbons, provided the temperature is not too high. Unlike rubber, fiber washer seals are considered as a single-use item.

Fiber sheet is easily die-cut to complex shapes and so it is widely used for shaped gaskets. These may be used for sealing, as heat insulators, or as mechanical spacers.

Until the development of modern plastics from the 1930s, fiber was the standard electrical insulating material for many small components. It could be cut to size easily, either in mass production or hand-trimmed to fit. It was particularly common in the assembly of large machines, such as motor winding.

Taylor, US Pat. No. 114,880 is titled, “Improvement in the Treatment of Paper And Paper-Pulp.” The object of the invention was to produce paper or paper-pulp (either sized, unsized, or partially sized) in such manner as to produce a change, more or less complete, in the fiber or material of which the paper is composed, whereby the texture and character of the paper are altered. The paper thus treated becomes less porous, acquires increased density, strength, stiffness, and durability, resists the action of water, and may be made to assume, to a greater or less extent, the toughness, semi-transparency, and general appearance of parchment. The invention consisted of soaking paper, when dry, in a concentrated neutral, or nearly neutral, solution of chloride of zinc, either at the natural temperature of the air, or moderately heated, and afterward thoroughly washing the paper in water.

The process started with paper made from cotton rags. Before the processing of wood pulp and chemical wood pulps in the mid-19th century, the dominant fiber source for paper making was cotton and linen rags. The cotton rag sheet produced for conversion to vulcanized fiber is made like a sheet suitable for saturating. A paper is made for saturating by omitting any sizing additive, either beater added or surface applied. Today most paper sheets made for writing, printing, and coating have internal (beater added) sizing provided by rosin, alkyl succinic anhydride (ASA), or alkyl ketene dimer (AKD) and surface sizing provided by starch. A sheet made for saturating would have none of those chemical ingredients. The unsized saturating cotton fiber paper prepared for vulcanized fiber would be passed through a vat containing a zinc chloride solution.

Zinc chloride is highly soluble in water. The solution used in saturating the paper was 70 Baumé in density (1.93 specific gravity) and about 43.3° C. (109.9° F.; 316.4 K). This is roughly a 70% percent zinc chloride solution. Zinc chloride is a mild Lewis acid with a solution pH of about 4. Zinc chloride can dissolve cellulose, starch, and silk. The zinc chloride used in making vulcanized fiber swelled and gelatinized the cellulose. The fiber swelling explains why paper filters cannot be used to filter zinc chloride solutions. It is also the reason why a number of paper plies were used to build up to the desired vulcanized fiber thickness, rather treating a single paperboard thickness. For instance, the practice was to use 8 paper plies of 0.04 mm thickness each, as opposed to a single paperboard ply of 0.32 mm.

Once the paper plies were saturated with the gelatinizing zinc chloride, they were pressed together. The pressing allowed intimate contact of the cellulose fibers, thus promoting bonding between the cellulose chains. Once the bonding was established, the process of leaching out the zinc chloride from the vulcanized fiber could begin. The leaching (removal by diffusion out) of the zinc chloride was accomplished by subjecting the vulcanized fiber to successively less concentrated baths of zinc chloride. The rate at which this could occur was constrained by osmotic forces. If the rate at which the vulcanized fiber was subjected to lower and lower concentrations of zinc chloride solution were too rapid, the osmotic forces could result in ply separations. The final leaching bath concentration was 0.05% zinc chloride. Thicknesses up to 0.093″ (=2.4 mm), can be made on continuous lines that stretch up to 1,000 feet (305 m) in length.

For thickness above 0.093″ (2.4 mm) and up to 0.375″ (9.5 mm), a discrete laminated sheet (similar in size (l×w) to plywood) was produced by the cutdown process. The cutdown sheets were racked and moved from vat to vat by overhead tracked cranes. Each vat was successively less concentrated until the desired 0.05% was reached. The thicker the material, the longer it took to leach the zinc chloride to 0.05%. For the thickest products, times of 18 months to 2 years were needed. The zinc chloride used in these processes was for the most part not consumed in achieving the desired bonding. Indeed any dilution of the zinc chloride resulting from the leaching was dealt with by using evaporators to bring the zinc chloride solution back to the 70 Baume needed for using it again for saturating. In a sense, zinc chloride can be thought of as a catalyst in the making of the vulcanized fiber.

Once the vulcanized fiber is leached free of the zinc chloride, it is dried to 5 to 6 percent moisture, and pressed or calendared to flatness. The continuous process-made vulcanized fiber could then be sheeted or wound up into rolls. The density of the finished vulcanized fiber is 2 to 3 times greater than the paper from which it starts. The density increase is the result of 10% machine direction shrinkage, 20% cross machine direction shrinkage, and 30% shrinkage in thickness.

The final product is a homogeneous nearly 100%-cellulose mass free from any artificial glues, resins, or binders. The finished vulcanized fiber has useful mechanical and electrical properties. It offers high tear and tensile strength, while in the thinner thicknesses allowing flexibility to conform to curves and bends. In thicker thicknesses, it can be molded to shape with steam and pressure. One application for vulcanized fiber that attests to its physical strength is that it is the preferred material for heavy sanding discs. Physical strength is anisotropic, owing to the roller calendaring process, with it typically being 50% stronger in the sheet's longitudinal direction, rather than transverse.

The electrical properties exhibited by vulcanized fiber are high insulating value, and arc and track resistance with service temperature of up to 110 to 120° C. Fiber was popular as an electrical insulator for a large part of the mid-20th century, not because its resistance as an insulator was particularly good, especially not if moisture levels were high, but it showed far better resistance to tracking and breakdown than early wood flour-filled polymers like Bakelite.

Vulcanized fiber shows high resistance to penetration by most organic solvents, oils, and petroleum derivatives.

Vulcanized Fiber is sold in several grades. Commercial Grade; standard grey, black or red, used for many applications such as washers, gaskets, gears, handles, etc. Electrical Grade: high dielectric grey, 100% cotton, very flexible, (historically called fishpaper), this grade is suitable for layer and ground insulation and has variations including top-stick grade used for wedges in small motors. Trunk Fiber: Tough and abrasion resistant; used to surface steamer trunks, drum cases, wear and skid panels. Bone Fiber: Exceptionally hard and dense, used for tight machining, tubing, pool cue ferrules (tips), cut out fuses. Wood Laminating: Tough, multi-directional tensile and torsion strength, provides support and strength wherever wood laminations are used, particularly used under thin and exotic veneers as a stabilizer/strengthener.

Hemp Paper

Electrical insulation and specialty papers are commercially available.

One hundred percent hemp machine made paper can be used for use in specialty packaging and printing. Hemp paper is renewable. One acre of hemp can produce as much paper as 4-10 acres of trees over a 20-year cycle. Hemp does not need pesticides or herbicides. Hemp has higher cellulose content. In contrast, trees are made up of only thirty percent (≥30%) cellulose. Producing paper from trees requires the use of toxic chemicals to remove the other seventy percent (70%) of the tree. Hemp can have up to eighty-fiver percent (≤85%) cellulose content. Hemp has lower lignin content than wood. Hemp contains five to twenty-four percent (5-24%) lignin, whereas wood has twenty to thirty-fiver percent (20-35%). This is advantageous as lignin must be removed from the pulp before it can be processed as paper. Hemp paper is more durable than trees. Hemp does not yellow, crack, or deteriorate like tree paper. Hemp is also one of the strongest natural fibers in the world, proving its longevity and durability. Hemp Paper does not require the use of toxic bleaching or other chemicals as wood pulp. Hemp can be whitened with hydrogen peroxide, which is consumed in the process. Hemp paper can be recycled up to eight time (≤8×); whereas, wood pulp can only be recycled three times (≤3×). Hemp is also compostable and biodegradable. Hemp paper produced has more stretch built into it. Hemp paper can stretch in both directions allowing it to be folded without the risk of cracking. This special process also greatly increases the ability of the paper to absorb energy without breaking when stressed.

Hemp paper is sold under the trademark 100% HEMP PAPER by Cottrell Paper Co.

Electrical Insulating Paper

Electrical insulation papers are paper types that are used as electrical insulation in many applications due to pure cellulose having outstanding electrical properties. Cellulose is a good insulator. Electrical paper products are classified by their thickness, with tissue considered papers less than 1.5 mils (0.0381 mm) thickness, and board considered more than 20 mils (0.508 mm) thickness.

Electrical insulation paper is sold under the trademark COPACO by Cottrell Paper Co. COPACO is a very robust electrical insulation product with extremely high tensile, tear, burst and dielectric properties. COPACO is normally supplied with a high density, very smooth “Glazed Roll” finish which eases the insertion into slot cells, and provides excellent abrasion resistance. The product is well suited to be punched, formed or creased. COPACO electrical insulating rag papers are manufactured from only high-grade new cotton cuttings, the stock is extensively cleaned and specially refined to insure maximum purity and physical strength. No sizing, clay, fillers, or other chemical additives are used in COPACO electrical insulation paper. The absence of impurities ensures that electrical insulation paper sold under the trademark COPACO has improved aging characteristics. Electrical insulation paper sold under the trademark COPACO is available from 0.002″ to 0.125″ in rolls, sheets, or coils slit to your specifications.

Extensible Electrical Insulating Paper

Extensible electrical insulating paper is made in a process that imbues the paper with twice the stretch of ordinary electrical insulating paper. This unusual elongation permits the extensible electrical insulating paper to stretch and absorb energy when subjected to extreme stress. The high tear resistance will virtually eliminate torn or split insulators when used under standard practices. The extensible paper process is entirely mechanical and in no way affects the high purity or chemical properties. Extensible electrical insulating paper is well suited to be punched, formed or creased.

Extensible electrical insulating paper is sold under the trademark COPACO 125 by Cottrell Paper Co. COPACO-125 is available from 0.002″ to 0.125″ in rolls, sheets, or coils.

Virgin Paper and Pressboard

Virgin paper and pressboard is made from 100% virgin fiber electrical insulating paper pulp. The stock is extensively cleaned and specially refined to insure maximum purity and physical strength. No sizing, clay, fillers, or other chemical additives are used. The absence of impurities ensures that the aging characteristics will meet the most exacting requirements.

Virgin paper and pressboard can be produced on a multi-ply cylinder machine, this technique allows for more bonds to form along the surface areas between plies in addition to fiber-to-fiber bonding in the machine direction. The resultant product exhibits outstanding physical strengths, including excellent elongation, which allows the paper to stretch without breaking. This proves especially beneficial in the fabrication of the 0.030″ to 0.125″ thickness, where the material must be rigid while still maintaining sufficient elongation to avoid tearing at the folds.

Virgin paper and press broad is commercially available under the trademark KRAFT by Cottrell Paper Co. This paper is made on a multi-ply-cylinder machine. Virgin paper and press board sold under the trademark KRAFT is available from 0.002″ to 0.125″ in rolls, sheets, or coils.

Thermally Upgraded Electrical Insulating Paper

Thermally upgraded electrical insulating paper is made from 100% virgin fiber electrical pulp. The stock is extensively cleaned and specially refined to insure maximum purity and physical strength. No sizing, clay, or fillers are used in the production of this sheet. The virgin paper is thermally upgraded to improve long term thermal aging properties. Thermally upgraded electrical insulating paper can be produced on a multi-ply cylinder machine, this technique allows for more bonds to form along the surface areas between plies in addition to fiber-to-fiber bonding in the machine direction. The resultant product exhibits outstanding physical strengths, including excellent elongation, which allows the paper to stretch without breaking. This proves especially beneficial in the fabrication of the 0.030″ to 0.060″ thickness, where the material must be rigid while still maintaining sufficient elongation to avoid tearing at the folds.

Thermally-upgraded electrical insulating paper is commercially available under the trademark KRAFT-TU by Cottrell Paper Co. KRAFT-TU is available from 0.002″ to 0.125″ in rolls, sheets, or coils.

Internally-Creped, Virgin, Thermally-Upgraded Insulating Paper

Internally-creped, virgin, thermally-upgraded insulating paper is manufactured under an extensible paper process that provides this material with approximately 20% elongation. This material is made from 100% virgin fiber electrical pulp. The unusual elongation permits this product to stretch and absorb energy when subjected to extreme stress. The ability of this paper to absorb energy provides this material with the capability of being used at higher wire wrapping speeds when used for CTC (continually transposed conductor) and magnet wire wrap. The extensible paper process is entirely mechanical and in no way affects the high purity or chemical properties of the product.

Internally-creped, virgin, thermally-upgraded insulating paper is sold under the trademark CK-125-TU by Cottrell Paper Co. CK-125-TU is available in 0.002″ to 0.125″ in rolls, sheets, or coils.

Electrical Insulating Paper

Electrical insulating paper can be made to meet standards: specifically ASTM D710 and IL-I-695. This grade can be manufactured in thicknesses from 0.002″ to 0.125″ in continuous rolls, sheets, or coils slit to your specifications. Electrical insulating paper is sold under the trademark ELECTRICAL INSULATING PAPER by Cottrell Paper Co.

Pressboard (LD & HD)

Pressboard, both low density (LD) and high density (HD) can be made from 100% virgin fiber electrical Kraft pulp. The stock is extensively cleaned and specially refined to insure maximum purity and physical strength. No sizing, clay, fillers, or other chemical additives are used. The absence of impurities ensures that the aging characteristics will meet the most exacting requirements. Pressboard is available from 0.002″ to 0.125″. Pressboard is widely used for barrier insulation, core insulation and spacing in transformers. Pressboard can be made with excellent elongation properties for various forming applications. Pressboard is also used in motors and other electrical applications where high dielectric and physical strengths are required. Pressboard can be materials conform to IEC-60641.

Pressboard is commercially available under the trademark PRESSBOARD by Cottrell Paper Co.

Specialty Paper & Boards

Specialty Papers and Boards manufactured can be used for many other non-electrical commercial and industrial applications. The following is a list of possible uses for specialty papers and boards: Gaskets, Glove Cuffs, Box Board, Tack Strip, Denim Paper, Flame Retardant Paper, Moisture Resistant paper, Music Rolls, Core Boards, Archival Products (7.0PH), Tags, Die-Cut Products, Beaming Paper, and mat board.

Specialty papers and boards are commercially available under the trademark PAPER & BOARDS by Cottrell Paper Co.

### SUMMARY OF THE INVENTION

An object of the invention is to provide waterproof paper utensils and methods for making the waterproof paper utensils that overcome the disadvantages of the materials of this general type and of the prior art.

A further object of the invention is to provide a waterproof paper laminate that is recyclable and biodegradable, made from all-natural and recycled material, and

The invention offers the end user, products tailored and printed with pigmentation (not conventional chemical inks) to suit customer's establishment and needs.

A further object of the invention is to provide an all-natural, non-petroleum-based laminate made from renewable resources.

A further object of the invention is to provide a product that can be used with existing machines that are currently used in the polyethylene-paper laminate process.

An object of the invention is to provide biodegradable utensils that maintain rigidity and performance characteristics after being submerged in 50° C. for at least five minutes.

In accordance with the objects of the invention, a composition is provided for waterproofing paper and cardboard. The composition includes a plant-derived wax having a melting point above the temperature for hot drinks, which is at least 60° C. The plant-derived wax should have similar processing qualities as low-density polyethylene (LDPE).

Sugarcane wax and rice bran wax are suitable types of plant-derived waxes. Sugarcane wax and rice bran wax are suitable coatings to waterproof paper because they have melting points above 60° C. and more preferably above 70° C. Sugarcane wax and rice bran wax have similar melting points as LDPE so pellets including sugarcane wax and/or rice bran wax can be used with existing machinery used to coat paper.

In accordance with the objects, the invention includes a recyclable waterproof laminate. The laminate can include a cellulose-based product, for example, a sheet of paper or board. On a surface of the cellulose-based product that is intended to face the liquid, a layer of the composition is disposed. A further layer of the composition can be applied to the opposing face of the cellulose-based product. The composition can be adhered directly to the surface of the cellulose-based product. Alternatively, additional layers (for example primers or sizing) can be added between the surface of the cellulose-based product and the layer of composition.

A process and machine of manufacture like the one described in U.S. Pat. No. 4,455,184, which is hereby incorporated by reference, can be used to manufacture the laminate. Pellets of the composition are placed in a hopper of the machine. The pellets are fed to a heater where they are melted. The molten composition is then extruded as a layer of molten composition. The layer of composition is disposed over the surface of the cellulose-based product to be waterproofed. The layers are passed between a pressure roll and a chiller roll to distribute and adhere the layer of composition to the cellulose-based product to produce the laminate.

A recyclable waterproof cup can be formed using the waterproofing composition described previously. In a first case, earlier-manufactured waterproof laminate can be cut and formed into a cup assembly. The cup assembly has a frustoconical wall with a circular bottom seated within the wall. The treated side of the paper is placed facing the inside of the cup. In a second case, a paper cup is assembled from paper that has not been treated with the composition. Then, the completed cup is sprayed with the waterproofing composition.

In accordance with the objects of the invention, treated paper for forming utensils is provided. The treated paper includes paper that has a waterproofing composition added to the paper.

The water proofing composition can include a first plant derived wax, a second plant derived wax, and a surfactant. The first plant-derived wax has a melting point above 70° C. The second plant-derived wax having a melting point above 70° C. In the waterproofing composition, at least 99.6% by weight of the composition is formed by said first and second plant-derived waxes.

In accordance with the objects of the invention, the paper can be vulcanized paper.

In accordance with the object of the invention, the paper can be any of the following.
Hemp paper, particularly hemp paper sold under the trademark HEMP PAPER by Cottrell Paper Company;
electrical insulating paper, particularly, the electrical insulating paper sold under the trademark COPACO by Cottrell Paper Company;
extensible electrical insulating paper, particularly, the electrical insulating paper sold under the trademark COPACO 125 by Cottrell Paper Company;
virgin paper and pressboard, particularly, the virgin paper and pressboard sold under the trademark KRAFT;
thermally upgraded electrical insulating paper, particularly the thermally-upgraded electrical insulating paper sold under the trademark KRAFT TU by Cottrell Paper Company;
internally-creped, virgin, thermally-upgraded insulating paper, particularly, the internally-creped, virgin, thermally-upgraded insulating paper sold under the trademark CK-125-TU by Cottrell Paper Company;
electrically insulating paper, particularly, the electrical insulating paper sold under the trademark ELECTRICAL INSULATING PAPER by Cottrell Paper Company;
pressboard, particularly, pressboard sold under the trademark PRESSBOARD by Cottrell Paper Company; and
specialty papers and board, particularly, specialty papers and boards sold under the trademark Cottrell Paper Co.

In accordance with the objects of the invention, a utensil for eating food includes a waterproofing composition and paper. The waterproofing composition can include a first plant-derived wax having a melting point above 70° C., a second plant-derived wax having a melting point above 70° C., a surfactant, and at least 99.6% by weight of the composition is formed by plant-derived waxes including at least said first plant-derived wax and said second plant-derived wax, and a group of surfactants including at least said surfactant. The paper is treated with said water proofing composition.

When forming utensils, the paper is formed to the shape of the utensil, typically, by molding. For example, the paper can be formed to the shape of a knife blade or a knife blade and handle. The paper can be formed to the shape of a fork. The paper can be formed to the shape a bowl of a spoon or to a bowl and handle of a spoon.

In accordance with the objects of the invention, a method for making a paper utensil is provided. The first step of the method is providing paper or paperboard. The next step is cutting the paper or paperboard to a shape of a utensil to create an untreated utensil. Although other methods of cutting are possible, die-cutting the paper is particularly efficient and produces an edge for forming a knife blade. The next step is dipping the untreated utensil into a waterproofing composition.

When making the utensil, before cutting the paper or paperboard, heating said paperboard to 116° C. can be performed.

When performing the method of making the utensil, using paper or paperboard with a grammage of at least 1.5 g/m². Using paper with a grammage of at least 2.5 g/m² is particularly useful.

Other features that are considered as characteristic for the invention are set forth in the appended claims.

Although the invention is illustrated and described herein as embodied in a recyclable composition for waterproofing paper utilizing a plant derived wax, pellets of the composition, recyclable waterproof paper laminate including the composition, recyclable hot beverage cups including the laminate, pods for making hot beverages including the laminate, and drinking straws including the laminate, the invention should not be limited to the details shown in those embodiments because various modifications and structural changes may be made without departing from the spirit of the invention while remaining within the scope and range of equivalents of the claims.

The construction and method of operation of the invention and additional objects and advantages of the invention is best understood from the following description of specific embodiments when read in connection with the accompanying drawings.

### BRIEF DESCRIPTION OF DRAWINGS

FIG. 1 is a left side elevational view of a knife according to the invention.

FIG. 2 is a bottom elevational view of the knife shown in FIG. 1

FIG. 3 is a bottom elevational view of a spork according to the invention.

FIG. 4 is a left side elevational view of the spork shown in FIG. 3.

FIG. 5 is a bottom elevational view of a spoon according to the invention.

FIG. 6 is a left side elevational view of the spoon shown in FIG. 5.

FIG. 7 is a bottom elevational view of a fork according to the invention.

FIG. 8 is left side elevational view of the fork shown in FIG. 7.

### DETAILED DESCRIPTION OF THE INVENTION

A preferred embodiment of a composition for waterproofing paper includes a mixture of sugarcane wax, rice-bran wax, and calcium stearate. The rice bran wax forms 95% of the composition by volume. The sugarcane wax forms 4.6% of the composition by volume. The calcium stearate forms 0.4% of the composition by volume.

A first preferred embodiment of the rice-bran wax is sold under the trade name RICE BRAN WAX 1# by Wuxi AccoBio Biotech, Inc.

A second preferred embodiment of the rice-bran wax is sold under the trade name RICE BRAN WAX 2# by Wuxi AccoBio Biotech, Inc.

The calcium stearate is commercially available.

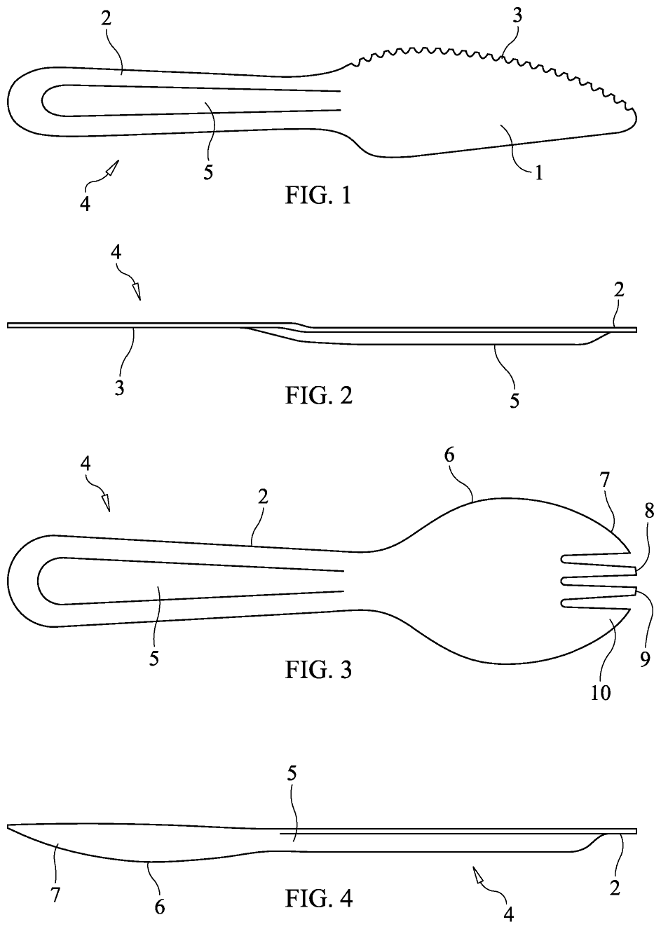

FIG. 1-2 show a preferred embodiment of a knife. The knife includes a blade 1 with a serrated edge 3. The knife includes a handle 4. The handle 4 includes a dimple 5 surrounded by a rim 2.

FIGS. 3-4 show a preferred embodiment of a spork. The spork includes a bowl 6 with four tines 7, 8, 9, 10. The bowl is connected to a handle 4. The handle 4 includes a dimple 5 surrounded by a rim 2.

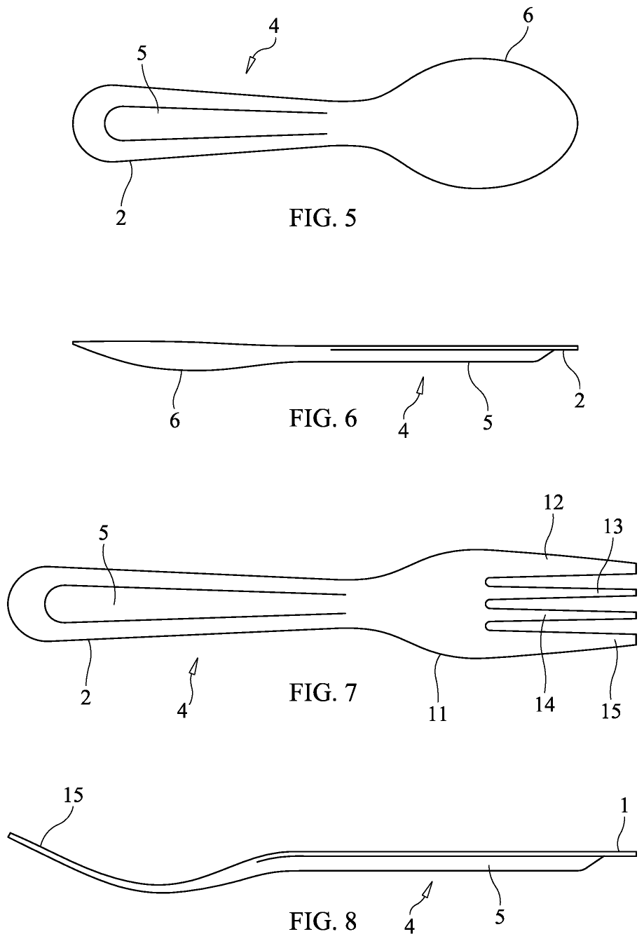

FIGS. 5-6 show a preferred embodiment of a spoon. The spoon includes a bowl 6. The bowl 6 is connected to a handle 4. The handle 4 includes a dimple 5 surrounded by a rim 2.

FIGS. 7-8 show a preferred embodiment of a fork. The fork includes a root 11. Four tines 12, 13, 14, and 15 extend from the root 11. A handle 4 connects to the root 11. The handle 4 includes a dimple 5 surrounded by a rim 2.

A preferred composition of the utensils shown in FIGS. 1-8 is paperboard. The paperboard is vulcanized and has the waterproofing composition absorbed and dried on exterior surfaces of the utensil.

The edges of the utensils are preferably crimped.

A preferred embodiment for making the utensils shown in FIGS. 1-8 includes the following steps. The first step involves providing a sheet of paperboard. The paperboard preferably has a grammage from 1.5-2.5 g/m². The next step is die cutting the paperboard to a shape of the desired utensil to form an uncured paperboard utensil: e.g., a fork, a knife, or a spoon. The next step is heating the uncured paperboard utensil to 116° C. to make a preheated uncured paperboard utensil. The next step is dipping the preheated uncured paperboard utensil in hot waterproofing composition. —Molded Paper Utensils were dipped in the waterproofing composition for one to two seconds (1-2 sec).

In a preferred embodiment, the die cut edges of the utensils are crimped to ensure plies of paper are well sealed before applying the waterproofing composition.

The invention has been described in an illustrative manner, and it is to be understood that the terminology which has been used is intended to be in the nature of words of description rather than of limitation.

What is claimed is:

1. Treated paper, comprising:
a waterproofing composition, including:
a first plant-derived wax having a melting point above 70° C.;
a second plant-derived wax having a melting point above 70° C.;
a surfactant; and
at least 99.6% by weight of said waterproofing composition is formed by plant-derived waxes including at least said first plant-derived wax and said second plant-derived wax, and a group of surfactants including at least said surfactant; and
paper being treated with said waterproofing composition.

2. The treated paper according to claim 1, wherein said paper is vulcanized paper.

3. The treated paper according to claim 1, wherein said paper is hemp paper.

4. The treated paper according to claim 1, wherein said paper is electrical insulating paper.

5. The treated paper according to claim 1, wherein said paper is extensible electrical insulating paper.

6. The treated paper according to claim 1, wherein said paper is virgin paper.

7. The treated paper according to claim 1, wherein said paper is pressboard.

8. The treated paper according to claim 1, wherein said paper is thermally upgraded electrical insulating paper.

9. The treated paper according to claim 1, wherein said paper is internally-creped, virgin, thermally-upgraded insulating paper.

10. The treated paper according to claim 1, wherein said paper is specialty paper.

11. The treated paper according to claim 1, wherein said paper has a grammage of at least 1.5 g/m².

12. The treated paper according to claim 11, wherein said grammage of said paper is at least 2.5 g/m².

13. A utensil for eating food, comprising:
a waterproofing composition, including:
a first plant-derived wax having a melting point above 70° C.;
a second plant-derived wax having a melting point above 70° C.;
a surfactant; and
at least 99.6% by weight of the composition is formed by plant-derived waxes including at least said first plant-derived wax and said second plant-derived wax, and a group of surfactants including at least said surfactant; and
paper being treated with said water proofing composition.

14. The utensil according to claim 13, wherein said paper forms a knife blade.

15. The utensil according to claim 13, wherein said paper forms a fork.

16. The utensil according to claim 13, wherein said paper forms a bowl of a spoon.

17. A method for making a paper utensil, comprising:
providing paperboard;
cutting said paperboard to a shape of a utensil to create an untreated utensil; and
dipping said untreated utensil into a waterproofing composition.

18. The method according to claim 17, which further comprises, before cutting said paperboard, heating said paperboard to 116° C.

19. The method according to claim 17, wherein said paperboard has a grammage of least 1.5 g/m².

20. The method according to claim 19, wherein said grammage of said paperboard is at least 2.5 g/m².

21. The method according to claim 17, wherein cutting said paperboard includes die cutting said paperboard.

22. The method according to claim 17, which further comprises selecting said paperboard from the group of paperboard consisting of vulcanized paper, hemp paper, electrical insulating paper, extensible electrical insulating paper, virgin paper and pressboard, thermally upgraded electrical insulating paper, internally-creped, virgin, thermally-upgraded insulating paper, pressboard, and specialty paper and board.
